(19) United States
(12) Patent Application Publication
(10) Pub. No.: US 2009/0076952 A1
(43) Pub. Date: Mar. 19, 2009

(54) VARIABLE CHARGING ASSIGNMENT FOR MULTI-SERVICE ENVIRONMENTS

(75) Inventors: Alejandro Cadenas, Madrid (ES); Javier Collado, Las Rozas de Madrid (ES); Ignacio Rivas, Madrid (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/854,571

(22) Filed: Sep. 13, 2007

(51) Int. Cl. G06Q 40/00

(52) U.S. Cl. 705/40; 705/35

(57) ABSTRACT

Methods, information processing systems, and wireless communication systems are disclosed for providing variable charging account assignment for multiple services. A request for a plurality of services is received from a wireless device (110), and a plurality of charging accounts associated with the wireless device (110) are identified. One of the charging accounts is selected for each of the services, with a first charging account being selected for a first of the services and a second charging account being selected for a second of the services (814). A first charging account identifier associated with the first charging account and a second charging account identifier associated with the second charging account are transmitted to a credit control server (120).

### FIELD OF THE INVENTION

The present invention generally relates to the field of wireless communications, and more particularly relates to charging multiple accounts associated with a wireless device for service usage.

### BACKGROUND OF THE INVENTION

Many current wireless communication systems provide multiple services to their subscribers. For example, a wireless device can access services of a wireless communication system that include Push-To-Talk Over Cellular (“PoC”), multimedia messaging, web browsing, VoIP, and multimedia streaming. Current online charging mechanisms for wireless communication networks (such as 2G/3G/IMS networks) always charge against a single charging account that is unique for a given subscriber. One problem with this approach is that it does not provide flexible billing services, especially in view of forthcoming multi-service environments.

More specifically, each service accessed by a wireless device is usually charged to a single charging account. If a user wants to have a different account billed for a particular service, the user is required to manually change a Subscriber Identity Module (“SIM”) card of the wireless device. Alternatively, a SIM card can include two TEL URLs that allow two different accounts to be used for charging services. However, with this approach each account requires a different phone numbers to be used. Thus, each of these approaches can be very cumbersome. A user either has to constantly swap SIM cards or switch phone numbers to charge services to different accounts.

Therefore a need exists to overcome the problems with the prior art as discussed above.

### SUMMARY OF THE INVENTION

Briefly, in accordance with the present invention, disclosed are methods, information processing systems, and wireless communications systems for providing variable charging account assignment for multiple services. According to the method of one embodiment, a request for services is received from a wireless device, and a plurality of charging accounts associated with the wireless device are identified. One of the charging accounts is selected for each of the services, with a first charging account being selected for a first of the services and a second charging account being selected for a second of the services. A first charging account identifier associated with the first charging account and a second charging account identifier associated with the second charging account are transmitted to a credit control server.

In another embodiment, an information processing system for providing variable charging account assignment for multiple services is disclosed. The information processing system includes a memory, and a processor that is communicatively coupled to the memory. The information processing system also includes a service registrar module communicatively coupled to the memory and the processor. The service registrar module is adapted to receive a request for a plurality of services from a wireless device, and identify charging accounts associated with the wireless device. One of the charging accounts is selected for each of the services, with a first charging account being selected for a first of the services and a second charging account being selected for a second of the services. A first charging account identifier associated with the first charging account and a second charging account identifier associated with the second charging account are transmitted to a credit control server.

In yet another embodiment, a wireless communication system for providing variable charging account assignment for multiple services is disclosed. The wireless communication system comprises base stations, and at least one information processing system that is communicatively coupled to at least one of the base stations. The information processing system includes a memory, and a processor that is communicatively coupled to the memory. The information processing system also includes a service registrar module communicatively coupled to the memory and the processor. The service registrar module is adapted to receive a request for a plurality of services from a wireless device, and identify a plurality of charging accounts associated with the wireless device. One of the charging accounts is selected for each of the services, with a first charging account being selected for a first of the services and a second charging account being selected for a second of the services. A first charging account identifier associated with the first charging account and a second charging account identifier associated with the second charging account are transmitted to a credit control server.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communication system according to an embodiment of the present invention;

FIG. 2 is a block diagram illustrating a general billing architecture for an IP Multimedia System;

FIG. 3 is a block diagram illustrating a conventional procedure for transmitting billing information in an IP Multimedia System;

FIG. 4 is a block diagram illustrating a variable account charging system according to an embodiment of the present invention;

FIG. 5 is a block diagram illustrating a wireless device according to an embodiment of the present invention;

FIG. 6 is a block diagram illustrating an information processing system according to an embodiment of the present invention;

FIG. 7 is an operational flow diagram illustrating a process for associating distinct charging accounts with services requested by a wireless device according to an embodiment of the present invention; and

FIG. 8 is an operational flow diagram illustrating another process for associating distinct charging accounts with services requested by a wireless device according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention.

Embodiments of the present invention provide flexible billing services to wireless network subscribers. A service registrar such as an S-CSCF can associate each individual requested service with a different account, without requiring a user to manually swap SIM cards or use multiple phone numbers. Additionally, a credit control server can grant/deny specific services, such as for reserving balance for specific usage. The process for performing conditional charging can occur in real time and with minimum effort.

Wireless Communications System

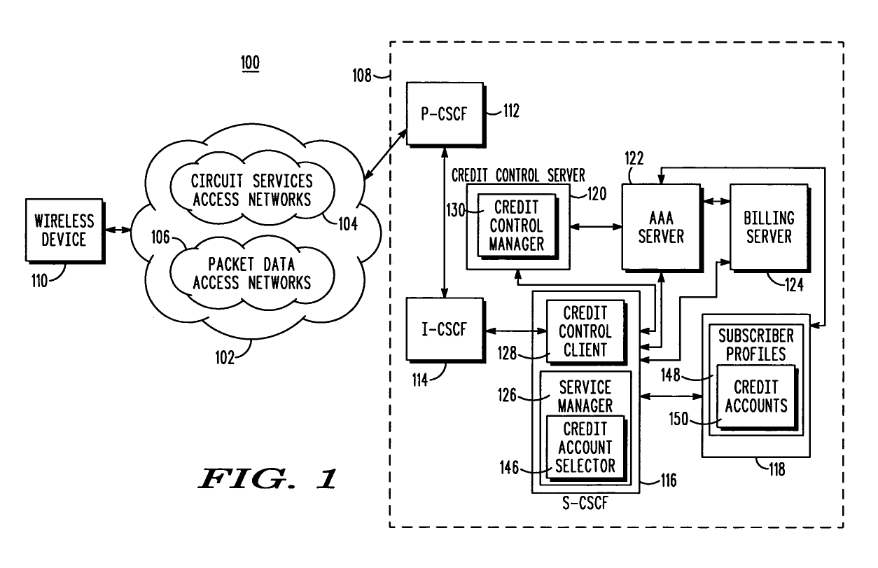

FIG. 1 shows one example of a wireless communication system 100 according to an embodiment of the present invention. The wireless communication system 100 includes one or more wireless devices 110 that are communicatively coupled to a wireless communication network 102. The wireless communication network 102 of this embodiment comprises one or more circuit service access networks 104 and packet data access networks 106. Each of these networks 104 and 106 can include an Internet Protocol Multimedia Subsystem (“IMS”) subsystem 108. The circuit service access network(s) 104 and the packet data access network(s) 106 can be in separate systems with one network being the home network of the wireless device 110 and the other network being a visited network. In other embodiments, the wireless communication system 100 only includes one of the circuit services network 104 and the packet data network 106.

In this embodiment, the circuit service access network(s) 104 provides, among other things, voice services to the wireless device 110. The packet data access network(s) 106 is an Internet Protocol (“IP”) connectivity network, which provides data connections at much higher transfer rates then a traditional circuit services network. The packet data access network(s) 106 of this embodiment comprises an Evolution Data Only (“EV-DO”) network, a General Packet Radio Service (“GPRS”) network, a Universal Mobile Telecommunications System (“UMTS”) network, an 802.11 network, an 802.16 (WiMax) network, Ethernet connectivity, dial-up modem connectivity, or the like.

Further, in this embodiment the communications standard of the circuit services access network(s) 104 and the packet data access network(s) 106 comprise Code Division Multiple Access (“CDMA”), Time Division Multiple Access (“TDMA”), Global System for Mobile Communications (“GSM”), General Packet Radio Service (“GPRS”), Frequency Division Multiple Access (“FDMA”), Orthogonal Frequency Division Multiplexing (“OFDM”), or the like. The access networks 104 and 106 also allow for push-to-talk over cellular communications between capable wireless communication devices. Additionally, the access networks 104 and 106 can comprise networks for other services such as a mobile text messaging device network, a pager network, or the like. Text messaging standards such as Short Message Service (“SMS”), Enhanced Messaging Service (“EMS”), Multimedia Messaging Service (“MMS”), and the like are included in such access networks.

The circuit services access network(s) 104 and the packet data access network(s) 106 support any number of wireless devices 110, which can be either single mode or multi-mode devices. In this embodiment, the access networks 104 and 106 can support mobile telephones, smart phones, text messaging devices, handheld computers, wireless communication cards, pagers, beepers, or the like. A smart phone is any mobile telephone that has additional application processing capabilities.

In the embodiment of FIG. 1, the wireless device 110 accesses the IMS network 108 via the packet data access network 106. IMS is a Next Generation Networking architecture for mobile and fixed IP services. IMS uses a Voice-over-IP implementation and runs over standard IP. A wireless device 110 can connect to the IMS network using different methods, which all use standard IP. For example, when a wireless device 110 wants to access the packet data access network 106, the wireless device 110 registers with the IMS network 108. The basic functions of an IMS network 108 are well known.

The IMS network 108 includes a Proxy Call Session Control Function (“P-CSCF”) component 112. The P-CSCF 112 is communicatively coupled to an Interrogating Call Session Control Function (“I-CSCF”) 114 within the IMS network 108. The I-CSCF 114 is communicatively coupled to a Serving Call Session Control Function (“S-CSCF”) 116 and a register such as a Home Subscriber Server (“HSS”) 118. Other components also reside within the IMS network 108. In this embodiment, the P-CSCF 112, I-CSCF 114, S-CSCF 116, and HSS 118 are part of a session initiation protocol (“SIP”) network. The SIP network is used for establishing instant messaging, telephone calls, and other real-time communications over the Internet. The SIP network allows for IP telephony services to be integrated into a wireless communication system.

The HSS 118 comprises a database including profiles 148 associated with each wireless device that is registered with the IMS 108. A profile 148 includes subscription related information and charging account information 150. The charging account information 150 indicates specific accounts that are to be billed for specific service usage. The HSS 118 also performs authentication and authorization of the wireless device 110, and provides information about the physical location to requesting entities. The HSS 118 also includes information to identify each registered wireless device 110, such as a telephone uniform resource identifier (“tel-URI”) and/or a SIP uniform resource identifier (“SIP-URI”). A tel-URI is the telephone number assigned to a wireless device. The P-CSCF 112, the I-CSCF 114, and the S-CSCF 116 are SIP servers (proxies) that are used to process SIP signaling packets in the IMS network.

The P-CSCF 112 is a SIP proxy and is the first contact point for a wireless device 110 registered in the IMS network 108. In this embodiment, the wireless device 110 locates its respective P-CSCF 112 via a dynamic host configuration protocol (“DHCP”). The wireless device 110 is assigned to a specific P-CSCF 112 for the duration of the device's subscription to the IMS network 108. All signaling messages are intercepted by the P-CSCF 112 to allow the P-CSCF 112 to inspect the messages. The P-CSCF 112 authenticates the wireless device 110 and is trusted by the other IMS components, which therefore do not perform further authentication of the wireless device 110. For example, after successful registration of a wireless device with the S-CSCF, security keys are sent to the P-CSCF 112, which allow it to setup a security association with the wireless device. The P-CSCF 112 can authenticate subsequent messages so that the other network entities, such as the I-CSCF 114 and S-CSCF 116, trust the messages. Other functions of the P-CSCF 112 are well known.

The I-CSCF 114 is also a SIP proxy. The IP address of the I-CSCF 114 is published in the domain name system (“DNS”) of the domain. This allows for remote servers such as a P-CSCF 112 residing in a visited domain or the S-CSCF 116 in a foreign domain to locate the I-CSCF 114. The remote servers use the I-CSCF 114 as an entry point for all SIP packets to the domain where the I-CSCF 114 is located. The I-CSCF 114 retrieves the location of the wireless device 110 so that a SIP request associated with the device 110 can be routed to the S-CSCF 116 assigned to the device 110. The I-CSCF 114 is the IMS entry point from other external networks.

The S-CSCF 116 is a SIP server, but also performs session control. The S-CSCF 116 is located in the home network of the wireless device 110. The S-CSCF 116 retrieves device profiles from the HSS 118. The S-CSCF 116 also handles SIP registrations, which allows the S-CSCF 116 to bind the location of the wireless device 110 (e.g., the IP address of the device) and the SIP address. The S-CSCF 116 can intercept all of the signaling messages in the IMS so that it can inspect each message.

The S-CSCF 116 also determines the application server(s) (“AS”) to which the SIP message associated with the wireless device 110 is forwarded so that the services subscribed to by the device 110 can be provided. Application servers host and execute various services that are subscribed to by a wireless device 110. For example, application servers can provide services such as call waiting, call forwarding, call conferencing, voice mail, SMS, MMS, and the like to a wireless device.

The HSS 116 includes profiles associated with wireless devices registered 110 within the IMS network 108. The profiles, among other things, identify the application servers associated with each wireless device registered 110 in the IMS network 108. In other words, a profile identifies the application server(s) that needs to be notified when a wireless device registers with the IMS network 108.

The IMS network 108, in this embodiment, also includes a credit control server 120, an Authentication, Authorization, and Accounting (“AAA”) server 122, and a billing server 124. The credit control server 120 manages and provides credit-control for end user services. For example, a wireless device 110 can access various services such as Push-To-Talk Over Cellular (“PoC”), multimedia messaging, web browsing, VoIP, multimedia streaming, and the like in the IMS network 108. The credit-control server 120 includes a credit-control manager 130 that determines potential charges associated with requested services, ensures user accounts include sufficient funds or are authorized for a requested service, and the like.

In this embodiment, the S-CSCF 116 includes a service manager 126 that manages all service requests received from a wireless device 110. The service manager 126 also includes a charging account selector 146 that selects a charging account associated with a wireless device 110that is to be billed for service usage. When a service request is received by the S-CSCF 116, it communicates with the credit-control server 120 via a credit-control client 128 to notify the credit-control server 120 of the service request. The S-CSCF 116, credit-control server 120, and HSS 118 are communicatively coupled to the AAA server 122. In this embodiment, the AAA server 122 authenticates and authorizes a wireless device 110 when a service request is received by the S-CSCF 116. One or more billing servers 124 are communicatively coupled to the credit-control server 120 and the AAA server 122 to provide billing functionality for one or more service providers.

General IMS Network Architecture for Billing

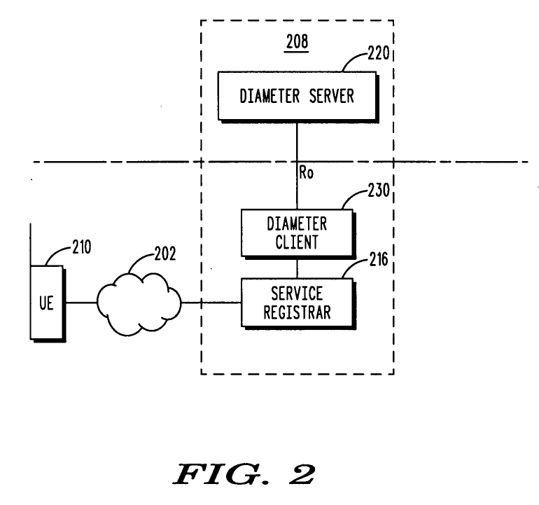

FIG. 2 is a block diagram illustrating a general IMS architecture for communicating billing information. Throughout this description, the DIAMETER protocol and an IMS network are used only as examples for the purposes of illustration. The present invention is similarly applicable to other protocols in which Subscription IDs are used, and other billing platforms. For example, any other Authentication, Accounting, and Authorization (“AAA”) protocol, such as Radius, Tacacs, Tacacs+, and the like, is usable with the present invention.

The IMS network 208 of FIG. 2 implements the DIAMETER protocol to carry billing information (e.g., any IMS or PoC network as per the 3GPP/IETF standards). The DIAMETER protocol was derived for the RADIUS protocol and is used as an Authentication, Authorization, and Accounting protocol. FIG. 2 shows a wireless device 210 accessing the IMS network 208 via a wireless communication network 202. A service registrar 216, which in this embodiment is the S-CSCF 116, is communicatively coupled to a DIAMETER client 230, which in this embodiment is the credit-control client 130. Although FIG. 2 shows the service registrar 216 and the DIAMETER client 230 as separate components, they can reside within a single component as shown in FIG. 1. The DIAMETER client 230 is communicatively coupled to a DIAMETER server 220, which in this embodiment is the credit-control server 120.

The DIAMETER Credit Control Application is described in IETF RFC 4006, which is herein incorporated by reference in its entirety. This application is an extension of the DIAMETER base protocol that is designed to handle online charging operations of different subscribers. The DIAMETER Credit Control Application specified in RFC 4006 defines two basic messages for handling credit requests: CCR (credit control request, sent from client to server) and CCA (credit control response, sent from server to client). In these messages information associated with the called party, calling party, specific application running, credit consumed, credit required, credit granted, and the like are carried in the form of AVPs (Attribute Value Pairs) inside each message.

There are two relevant AVPs in the CCR/CCA messages: Subscription-ID and Multiple-Services-Credit-Control (“MSCC”). The Subscription-ID includes the subscription account to which any charging (there are also free services) is to be routed. This is usually given by the identifier of the calling party. The MSCC AVP is included in the CCR messages and includes the service units (talking time, traffic volume, and the like) that the DIAMETER client is requesting. If the MSCC AVP is included in the CCA message, the MSCC AVP includes service units granted by the DIAMETER server 220. The MSCC AVP also includes the amount of service units consumed during the session up to the moment the DIAMETER message is sent.

The MSCC AVP can also include information to link the specific application that the wireless device 210 is triggering to the specific pool of service units reserved by the DIAMETER server 220. Information about the time during which the credit units granted are valid can also be included in the MSCC AVP. Once that time expires, if the granted service units have not been used, the DIAMETER client 230 requests quota re-authorization. The MSCC AVP also includes information regarding why the report is being made (quota exhausted, etc.), as well as information about the trigger that generated the quota reauthorization (change in location, in QoS characteristics, and the like).

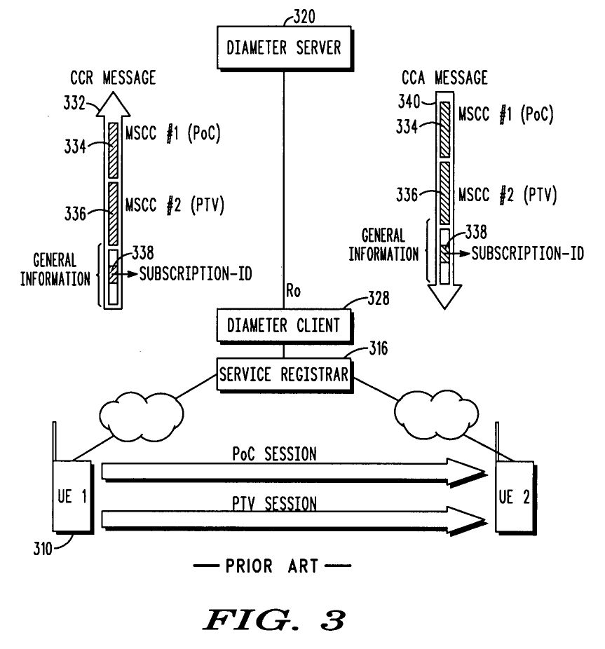

There can be several instances of the MSCC AVP in the CCR/CCA. Each instance of the MSCC AVP can carry the credit information for each one of the applications running at a given moment for the wireless device 210 for which the DIAMETER dialogue is being carried. However, in current networks the credit pools included in these possible instances of the MSCC AVP are always pointing to the charging account given by the single Subscription-ID AVP included in the DIAMETER message that is common to all MSCC AVPs. FIG. 3 is a block diagram illustrating DIAMETER CCR/CCA transmissions in conventional networks. In particular, FIG. 3 shows a wireless device 310 requesting a PoC session and Push-To-View (“PTV”) session. (PTV is a service for sending video images from one handset to another using the digital camera on the phone.) The service registrar 316, via its DIAMETER client 320 sends a CCR message 322 to the DIAMETER server 324.

The CCR message 322 includes a first MSCC AVP 334 associated with the PoC session and a second MSCC AVP 336 associated with the PTV session. The CCR message 332 also includes general information comprising a single Subscription-ID 338 that is common to both MSCC AVPs 334 and 336. The DIAMETER server responds with a CCA message 340 comprising each of the MSCC AVPs 334 and 336 and the Subscription-ID 338. Thus, the same user account is charged for both the PoC session and the PTV session. This is not desirable in all situations; some users may want to have a first account charged for the PoC session and a second account charged for the PTV session.

Variable Account Charging System

Embodiments of the present invention provide a variable charging procedure that independently specifies the charging account for different services. For example, subscriber profiles residing at a registrar (such as the HSS 118) can indicate various accounts that are to be charged based on services used, time of day, location, and the like. This allows service providers to offer a wide variety of differentiated charging services with value added functionalities to its subscribers. For example, a service provider can provide the service equivalent of multiple-SIM, but with a single subscription and without the need to change SIM cards. The distinction between two or more charging accounts (e.g., for private versus company-paid calls) is automatically made by the network by following certain subscription rules. This charging account selection can be completely transparent to the end user.

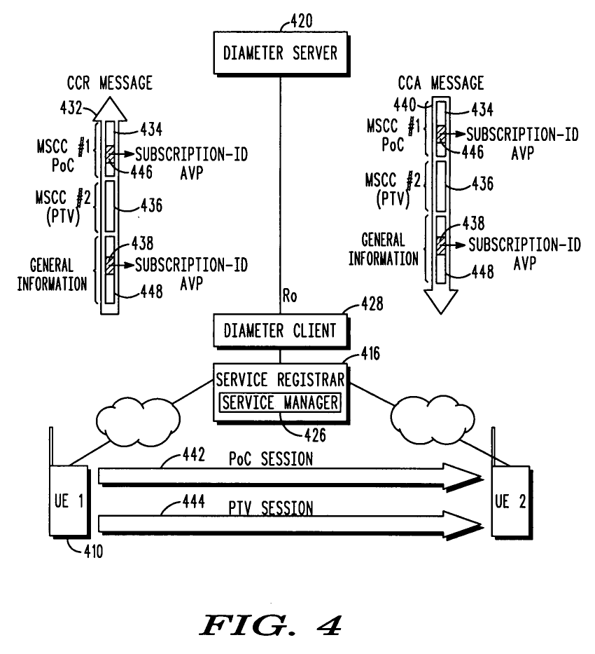

FIG. 4 is a block diagram illustrating a variable charging assignment procedure according to one embodiment of the present invention. In this embodiment, an instance of the Subscription-ID can be provided in each MSCC instance. This enables the Service Registrar 416 to select the charging account independently for each service being requested (according to a subscriber profile) and to implement a wide range of value added functionalities. More specifically, a Subscription-ID AVP is an optional element in each of the MSCC instances of a CCR/CCA message in order to be backwards compatible with implementations that do not include such functionality.

These Subscription-ID AVP instances are included in the profile database 118 for the subscriber, and are associated with a specific application and to specific settings of the session (like called parties of a specific domain or group, such as family or company colleagues). This way specific sessions with given settings can be charged to a different account. The Service Registrar 416 (the PoC CS in the case of PoC, the S-CSCF in case of IMS, etc.) is then able to charge each individual application to a different account. The DIAMETER server 424 can implement different algorithms to grant/deny service for each application, like reserving balance for specific usage, etc. These algorithms that perform conditional charging (against one or another subscription accounts) can happen in real time, such as for prepaid services, and with minimum effort or any post-processing required of the UDRs

In the exemplary exchange shown in FIG. 4, a wireless device 410 requests a PoC session 442 and PTV session 444. The service manager 426 residing within the service registrar 416 receives the PoC and PTV session requests 442 and 444. The service registrar 416 retrieves subscription profiles 148 from the HSS 118. These subscription profiles 148 can indicate multiple charging accounts that are independently charged for the service based on criteria such as the service used, time of day, location, and the like. The charging account selector 146 then selects one or more appropriate charging accounts that are to be charged for the PoC and PTV sessions 442 and 444. In this example, a first account is selected to be charged for the PoC session 442 and a second account is selected to be charged for the PTV session 444.

The service registrar 416, via its diameter client 420, generates a CCR message 432. The CCR message includes a first MSCC AVP 434 associated with the PoC session 442 and a second MSCC AVP 436 associated with the PTV session 444. The service registrar 416, via its DIAMETER client 420, includes a separate and distinct Subscription-ID 446 and 447 in each of the MSCC AVPs 434 and 436. This indicates to the DIAMETER server 424 and billing server 124 which specific charging account to charge for the service associated with each of the MSCC AVPs 434 and 436.

The service registrar 416 also includes general information 448, which in this embodiment includes another Subscription-ID 438 that is associated with a default charging account. If a MSCC AVP such as the second MSCC AVP 436 does not includes a Subscription-ID, the default Subscription-ID 438 from the general information is used for charging the service associated with the second MSCC AVP 436.

The CCR message 432 is sent to the DIAMETER server 424, which in turn transmits a CCA message 440 back to the service registrar 416 via the DIAMETER client 420. The example of FIG. 4 shows that the CCA message 440 includes the first MSCC AVP 434 associated with the PoC session 442 and its corresponding Subscription-ID 446, the second MSCC AVP 436 associated with the PTV session 444 and its corresponding Subscription-ID 447, and the general information including the Subscription-ID 438 associated with the default charging account. This CCA message 440 is a response to the CCR message 432 that is sent to acknowledge that the request was processed correctly. Typically the information from the CCR message 432 is included in the CCA message 440 as shown in FIG. 4, but this is not required. For example, in one embodiment the CCA message 440 includes only the Session-Id, Result-Code, Origin-Host, Origin-Realm, Auth-Application-Id, CC-Request-Type, and CC-Request-Number AVPs. Once the service registrar 416 receives the CCA message 440 from the DIAMETER server 424, the wireless device 110 is allowed to perform the requested services. Each of these services is billed to separate accounts according to the Subscription-ID in the MSCC AVP for each service.

Accordingly, embodiments of the present invention provide flexible billing services to wireless network subscribers. The service registrar can charge each individual application (or service) to a different charging account without a user having to manually intervene (such as by swapping SIM cards, using multiple phone numbers, and the like). The credit control server can individually grant/deny service for each requested application, such as for reserving balance for specific usage, etc. The process for performing conditional charging can occur in real time, with minimum effort, and without any post-processing required of the UDRs.

In another embodiment of the present invention, separate DIAMETER dialogues are established for each separate session/service that is to be charged against a distinct charging account. In this embodiment, for each DIAMETER dialogue the Subscription-ID is associated with a different value. Additional information is included in the subscriber profile 148 regarding the specific subscription accounts to which services are to be charged. These subscriber profiles 148, along with the additional charging account information, are downloaded from the HSS 118 to the service registrar 416. The service registrar 416 initiates a separate DIAMETER session based on the settings from the subscriber profile 148 (each one with different account information). From the DIAMETER client-server point of view, the whole functionality of this embodiment is transparent, but the end-to-end functionality is the same.

A few examples will now be given to illustrate specific applications for the variable charging service of the present invention. The first example provides a dual charging wireless device. In this example, a PoC service user has a company-paid handset, but the company does not pay for personal calls. A personal call is identified by the service registrar if at least one of the participants on the call does not belong to the company. The service registrar charges PoC calls against the company account if and only if all the participants on a call work for the company. These settings are included in and retrieved from the subscriber profile database. The user thus has “dual SIM card” type service because the wireless device can be used for company purposes (with the company paying for company calls in real time) and also for personal purposes as well (with the user paying for these calls). Alternatively, a user's company may pay for all calls, but not for any downloads. In such a case, the service registrar selects the company's charging account for all calls made by the user and selects the user's charging account for downloads performed by the user. Each charging account can be prepaid or a credit-based account, without regard to the other.

In such company-personal situations in which the company only pays for specific services (identified by the service itself, the type of participants in the session, or other criteria), the company account may have a limit controlled by some external administrator (either human or automatically). The external administrator can generate an alarm when the balance consumed by an individual exceeds a given threshold, and then triggers a logic module in order to grant or deny the establishment of the next session requested by the specific user. This provides effective cost control for the company as it can limit the amount of credit for each employee, such as on a monthly basis. This can also be applied to other scenarios such as family plans.

Another example is directed toward a family plan. In this example, a user has a family subscription that routes the charging requests for all calls to the family account (managed by a parent for instance). However, other services like downloading games, chat services, and the like are not covered by the family plan but instead must be paid directly by the user. In this example, based on the type of service requested, the service registrar uses the CCR/CCA messages to charge the family charging account for all calls made by the user, and to charge any other type of service not to the family charging account but to the user's personal charging account. If the user has only a prepaid charging account, calls can always be made while other services are denied unless there is a balance in the user's prepaid charging account.

Yet another example is directed toward emergency balance assignment. In this example, the operator can offer the service of emergency balance assignment. That is, even if the balance of a prepaid subscriber is zero so as to prevent voice calls from being established in a prepaid mode, the operator can grant an extra balance to a trustworthy subscriber (e.g., that has been subscribed for over one year) to establish an “emergency” (i.e., not “911”) regular voice call. That balance could be extracted from another member of the family plan that has balance (in order to avoid revenue leakage), or can be a credit granted by the operator to be charged back later when the user adds additional funds to the account (potentially at a higher price). This is done by the service registrar requesting the voice call to be established against a specific charging account other than the user's normal prepaid charging account, as the user is considered to be trustworthy and has no balance left in the prepaid charging account to establish the call.

The above examples are not meant to be limiting. The present invention is applicable to any scenario in which there is the capability of differentiating the specific charging account against which a specific service is to be charged.

Processes for Associating Multiple Charging Accounts with Multiple Services

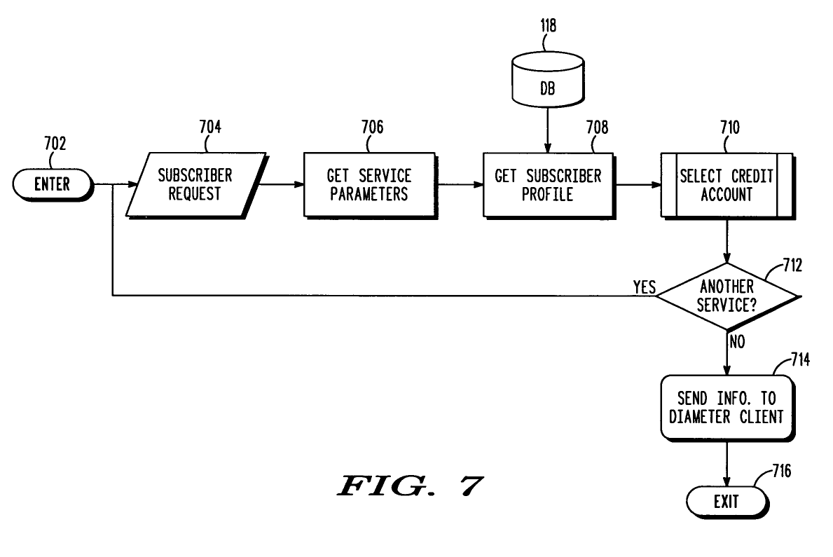

FIG. 7 is an operational flow diagram illustrating a process for selecting distinct charging accounts for services requested by a wireless device according to one embodiment of the present invention. The operational flow diagram of FIG. 7 begins at step 702 and flows directly to step 704. The S-CSCF 116, at step 704, receives a service request from a wireless device 110. The S-CSCF 116, at step 706, retrieves parameters associated with the requested services. A subscriber profile 148 associated with the wireless device 110 is retrieved from the HSS 118, at step 708. The S-CSCF 116, at step 710, selects a charging account to be charged for the requested service based on information within the retrieved profile 148. The S-CSCF 116, at step 712, determines if the wireless device 110 has requested an additional service. If the result of this determination is positive, the control flow returns to step 704. If the result of this determination is negative, the S-CSCF 116, at step 714, sends information associated with the requested service(s), including the selected charging account for each service, to its credit control client 128. The control flow then exits at step 716.

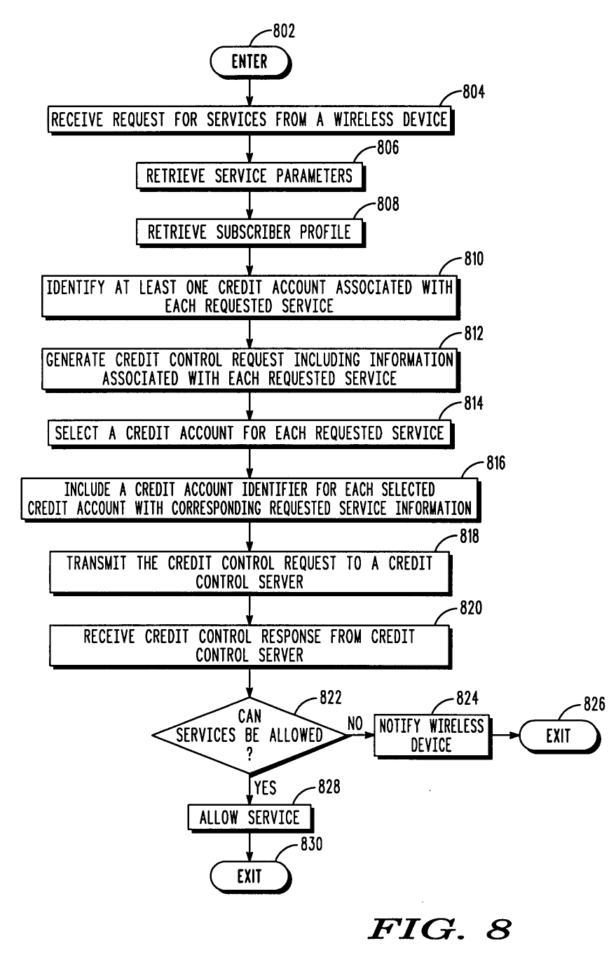

FIG. 8 is an operational flow diagram illustrating a process for selecting distinct charging accounts for services requested by a wireless device according to another embodiment of the present invention. The operational flow diagram of FIG. 8 begins at step 802 and flows directly to step 804. The S-CSCF 116, at step 804, receives one or more requests for services from a wireless device 110. The S-CSCF 116, at step 806, retrieves and determines parameters associated with each requested service.

The S-CSCF 116, at step 808, retrieves the subscriber profile 148 associated with the wireless device 104 from the HSS 118. At step 810, at least one charging account associated with each requested service is identified based on the retrieved subscriber profile 148. The S-CSCF 116, at step 812, generates a credit control request including information associated with each requested service. One charging account is selected by the service manager for each requested service, at step 814. A specific account or a default account can be selected for each service. The S-CSCF 116, at step 816, includes, for each requested service, a charging account identifier for the selected charging account in the credit control request.

The S-CSCF 116, at step 818, transmits the credit control request to a credit control server 120. The S-CSCF 116, at step 820, receives a credit control response from the credit control server 120. The S-CSCF 116, at step 822, determines if the services can be granted to the wireless device 104. If the result of this determination is negative, the S-CSCF 116, at step 824, notifies the wireless device 104. The control flow then exits at step 830. If the result of this determination is positive, the S-CSCF 116, at step 828, grants the service. The control flow then exits at step 830.

Wireless Device

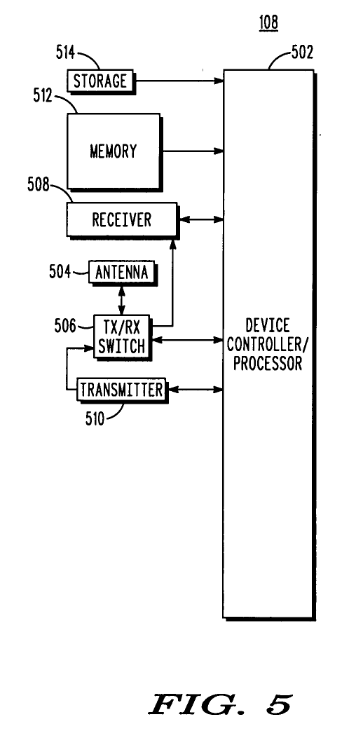

FIG. 5 is a block diagram illustrating a detailed view of a wireless device according to an embodiment of the present invention. It is assumed that the reader is familiar with wireless communication devices. To simplify the present description, only that portion of a wireless communication device that is relevant to the present invention is discussed. The wireless device operates under the control of a device controller/processor 502 that controls the sending and receiving of wireless communication signals. In receive mode, the device controller 502 electrically couples an antenna 504 through a transmit/receive switch 506 to a receiver 508. The receiver 508 decodes the received signals and provides those decoded signals to the device controller 502.

In transmit mode, the device controller 502 electrically couples the antenna 504, through the transmit/receive switch 506, to a transmitter 510. In this embodiment, the receiver 508 and the transmitter 510 are a dual mode receiver and a dual mode transmitter for receiving/transmitting over various access networks providing different air interface types. In another embodiment, a separate receiver and transmitter is used for each of type of air interface. The device controller 502 operates the transmitter and receiver according to instructions stored in the memory 512. These instructions include, for example, a neighbor cell measurement-scheduling algorithm. The wireless device also includes non-volatile storage memory 514 for storing, for example, an application waiting to be executed on the wireless device.

Information Processing System

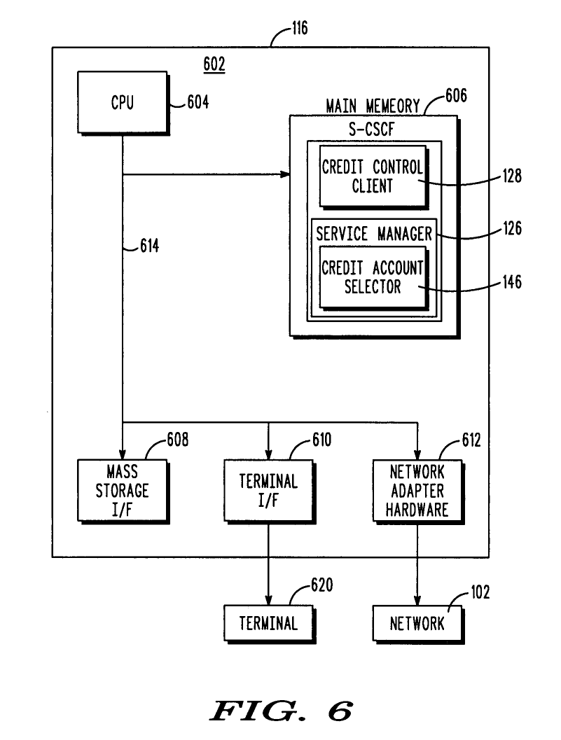

FIG. 6 is a block diagram illustrating an information processing system according to an embodiment of the present invention. The information processing system is based upon a suitably configured processing system adapted to implement an embodiment of the present invention. For example, a personal computer, workstation, or the like, may be used. The information processing system includes a computer 602 having a processor 604 that is connected to a main memory 606, a mass storage interface 608, a terminal interface 610, and network adapter hardware 612. A system bus 614 interconnects these system components.

The main memory 606 includes at least the S-CSCF 116. The S-CSCF 116, in the embodiment discussed above, includes the service manager 126, charging account selector 146, and the credit control client 128. Although illustrated as concurrently resident in the main memory 606, it is clear that respective components of the main memory 606 are not required to be completely resident in the main memory 606 at all times or even at the same time. One or more of these components can be implemented as hardware.

Although only one CPU 604 is illustrated for computer 602, computer systems with multiple CPUs can be used equally effectively. Embodiments of the present invention further incorporate interfaces that each include separate, fully programmed microprocessors that are used to off-load processing from the CPU 604. Terminal interface 610 is used to directly connect one or more terminals 620 to computer 602 to provide a user interface to the information processing system. These terminals 620, which are able to be non-intelligent or fully programmable workstations, are used to allow system administrators and users to communicate with the information processing system. The terminal 620 may also include user interface and peripheral devices that are connected to computer 602 and controlled by terminal interface hardware included in the terminal I/F 610 that includes video adapters and interfaces for keyboards, pointing devices, and the like.

The network adapter hardware 612 is used to provide an interface to the public network 118 and/or any of the access networks 102,104, and 106. Embodiments of the present invention are able to be adapted to work with any data communications connections including present day analog and/or digital techniques or via a future networking mechanism. Although the embodiments of the present invention are described in the context of a fully functional computer system, other embodiments are capable of being distributed as a program product via floppy or optical disk, e.g., CD/DVD, or another form of recordable media, or via any type of electronic transmission mechanism.

The term wireless communication device is intended to broadly cover many different types of devices that can wirelessly receive signals, and optionally can wirelessly transmit signals, and may also operate in a wireless communication system. For example, and not as a limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like. A multi-mode wireless device is intended to broadly cover any wireless device that can communicate using more than one communication service such as PTT/PoC, cellular, Voice Over IP (“VoIP”), data packet transfer, or the same type of communication service but on different networks.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Although specific embodiments of the present invention have been disclosed, those having ordinary skill in the art will understand that changes can be made to the specific embodiments without departing from the spirit and scope of the present invention. The scope of the present invention is not to be restricted, therefore, to the specific embodiments, and it is intended that the appended claims cover any and all such applications, modifications, and embodiments within the scope of the present invention.

What is claimed is:

1. A method for providing variable charging account assignment for multiple communication services, the method comprising the steps of:
receiving, from a wireless device, a request for a plurality of communication services;
identifying a plurality of charging accounts associated with the wireless device from a profile of the wireless device, each account associated with different communications services for the wireless device;
selecting one of the charging accounts for each of the communication services, such that a first charging account is selected for a first of the communication services and a second charging account is selected for a second of the communication services; and
transmitting a first charging account identifier associated with the first charging account for the first communication service and a second charging account identifier associated with the second charging account for the second communication service in one credit control request message to a credit control server.

2. The method of claim 1, wherein the transmitting step includes associating specific charging account identifiers with specific settings of a communication session.

3. (canceled)

4. The method of claim 1, wherein the transmitting step comprises:
transmitting a credit control request that includes an attribute value pair for each of the services that was requested, each of the attribute value pairs including information for identifying one of the services that was requested,
wherein one of the attribute value pairs includes the first charging account identifier and information for identifying the first service, and another of the attribute value pairs includes the second charging account identifier and information for identifying the second service.

5. The method of claim 1, wherein the transmitting step comprises:
transmitting at least first and second credit control requests,
wherein the first credit control request includes a first attribute value pair comprising information for identifying the first service, and a second attribute value pair comprising the first charging account identifier, and
the second credit control request includes a third attribute value pair comprising information for identifying the second service, and a fourth attribute value pair comprising the second charging account identifier.

6. The method of claim 1, wherein the transmitting step comprises:
transmitting the credit control request including an attribute value pair for each of the services that was requested, each of the attribute value pairs including information for identifying one of the services that was requested,
wherein one of the attribute value pairs includes the first charging account identifier and information for identifying the first service, and another of the attribute value pairs includes information for identifying the second service but does not include any charging account identifier so as to indicate that a default charging account is associated with the second service.

7. The method of claim 1, further comprising the step of billing the first service to the first charging account and the second service to the second charging account.

8. An information processing system for providing variable charging account assignment for multiple communication services, the information processing system comprising:
a memory;
a processor communicatively coupled to the memory; and
a service registrar module communicatively coupled to the memory and the processor, wherein the service registrar module is adapted to:
receive, from a wireless device, a request for a plurality of communication services;
identify a plurality of charging accounts associated with the wireless device from a profile of the wireless device, each account associated with different communications services for the wireless device;
select one of the charging accounts for each of the communication services, such that a first charging account is selected for a first of the communication services and a second charging account is selected for a second of the communication services; and
transmit a first charging account identifier associated with the first charging account for the first communication service and a second charging account identifier associated with the second charging account for the second communication service in one credit control request message to a credit control server.

9. The information processing system of claim 8, wherein the service registrar module associates specific charging account identifiers with specific settings of a communication session of the wireless device.

10. (canceled)

11. The information processing system of claim 8,
wherein the service registrar module transmits by transmitting a credit control request that includes an attribute value pair for each of the services that was requested, each of the attribute value pairs including information for identifying one of the services that was requested, and
one of the attribute value pairs includes the first charging account identifier and information for identifying the first service, and another of the attribute value pairs includes the second charging account identifier and information for identifying the second service.

12. The information processing system of claim 9,
wherein the service registrar module transmits by transmitting at least first and second credit control requests,
the first credit control request includes a first attribute value pair comprising information for identifying the first service, and a second attribute value pair comprising the first charging account identifier, and
the second credit control request includes a third attribute value pair comprising information for identifying the second service, and a fourth attribute value pair comprising the second charging account identifier

13. The information processing system of claim 8,
wherein the service registrar module transmits by transmitting the credit control request including an attribute value pair for each of the services that was requested, each of the attribute value pairs including information for identifying one of the services that was requested, and
one of the attribute value pairs includes the first charging account identifier and information for identifying the first service, and another of the attribute value pairs includes information for identifying the second service but does not include any charging account identifier so as to indicate that a default charging account is associated with the second service.

14. The information processing system of claim 8, wherein the service registrar is further adapted to bill the first service to the first charging account and the second service to the second charging account.

15. A wireless communication system for providing variable charging account assignment for multiple services, the wireless communication system comprising:
a plurality of base stations communicatively coupled to wireless devices; and
at least one information processing system communicatively coupled to at least one of the base stations,
wherein the at least one information processing system includes:
a memory;
a processor communicatively coupled to the memory;
a service registrar module communicatively coupled to the memory and the processor, the service registrar module being adapted to:
receive, from a wireless device, a request for a plurality of communication services;
identify a plurality of charging accounts associated with the wireless device from a profile of the wireless device, each account associated with different communications services for the wireless device;
select one of the charging accounts for each of the communication services, such that a first charging account is selected for a first of the communication services and a second charging account is selected for a second of the communication services; and
transmit a first charging account identifier associated with the first charging account for the first communication service and a second charging account identifier associated with the second charging account for the second communication service in one credit control request message to a credit control server.

16. The wireless communication system of claim 15, wherein the service registrar module associates specific charging account identifiers with specific settings of a communication session of the wireless device.

17. (canceled)

18. The wireless communication system of claim 15,
wherein the service registrar module transmits by transmitting a credit control request that includes an attribute value pair for each of the services that was requested, each of the attribute value pairs including information for identifying one of the services that was requested, and
one of the attribute value pairs includes the first charging account identifier and information for identifying the first service, and another of the attribute value pairs includes the second charging account identifier and information for identifying the second service.

19. The information processing system of claim 15,
wherein the service registrar module transmits by transmitting at least first and second credit control requests, and
the first credit control request includes a first attribute value pair comprising information for identifying the first service, and a second attribute value pair comprising the first charging account identifier, and wherein the second credit control request includes a third attribute value pair comprising information for identifying the second service, and a fourth attribute value pair comprising the second charging account identifier.

20. The wireless communication system of claim 16, wherein the service registrar is further adapted to bill the first service to the first charging account and the second service to the second charging account.
